(19) United States
(12) Patent Application Publication
(10) Pub. No.: US 2011/0286152 A1
(43) Pub. Date: Nov. 24, 2011

(54) MECHANICAL AND ELECTRICAL SYSTEM FOR POWERING SHELF-EDGE ELECTRONIC DISPLAYS IN A RETAIL ENVIRONMENT

(75) Inventors: Robert Wolinsky, Fairfield, CT (US); Peter Daly, Yorktown Heights, NY (US); Mikhail Marsky, Ramsey, NJ (US); Peter Goldring, Edgewater, NJ (US)

(73) Assignee: Automated Media Services, Inc.

(21) Appl. No.: 13/103,849

(22) Filed: May 9, 2011

Related U.S. Application Data
(60) Provisional application No. 61/332,503, filed on May 7, 2010.

(51) Int. Cl. H02B 1/00; H01R 43/00

(52) U.S. Cl. 361/601; 29/825

(57) ABSTRACT

A power bus system and method for providing electrical power to an electronic device at a shelf of a gondola in a retail environment may include a power track including a structure member and at least two electrical conductors. The structure member may be positioned along a bottom surface of the shelf of the gondola. A shuttle may be coupled to the power track, and configured (i) to be positionable along the power track and (ii) to conduct electricity from the at least two electrical conductors to the electronic device. A box holder may be connected to the shuttle, and be configured to physically support the electronic device.

### RELATED APPLICATIONS

This patent application claims priority to co-pending U.S. Provisional patent application Ser. No. 61/332,503 filed May 7, 2010, the entire contents of which are herein incorporated by reference in their entirety.

### BACKGROUND

There are a number of reasons why digital signage and other forms of electronic display media has not been embraced in retail environments. One such reason is that cost for installation of more than a couple of electronic displays is expensive. Part of the high expense for installation is each electronic display has required a special installation, including mechanical hardware and electrical components. As a result, the costs for installation has been too high for business economics to make practical sense. Another problem that has existed is the ability to design device installation hardware that provides safety to customers of a retailer when the device installation hardware is located where customers, including children, and reach the hardware that may include electrical power, and is secure from being damaged or stolen.

### SUMMARY

To overcome the problems of historically expensive and insecure techniques for installing electronic displays in a retail environment, the principles of the present invention provide for a universal installation of a power bus that is capable of delivering power to retail store shelves in an economical manner. The power bus may also be configured to deliver electronic data signals to electronic displays connected to the power bus. Such an approach includes distributing electrical power to electrical conductors positioned within a support structure, including a power tube that extends along a top of a gondola and under-shelf power track. The support structure can both physically support electronic displays and provide electricity via electrical conductors that extend along the support structure. A power track that may be mounted beneath shelves. The under-shelf power track may be configured to support a shuttle onto which an electronic display may be mounted. The shuttle may provide power conductors that can slide along power rails on the power track, thereby providing adjustability for positioning (i) the power track under the shelf and (ii) the electronic display at the shelf-edge.

One embodiment of a power bus system for providing electrical power to an electronic device at a shelf of a gondola in a retail environment may include a power track including a structure member and at least two electrical conductors. The structure member may be positioned along a bottom surface of the shelf of the gondola. A shuttle may be coupled to the power track, and configured (i) to be positionable along the power track and (ii) to conduct electricity from the at least two electrical conductors to the electronic device. A box holder may be connected to the shuttle, and be configured to physically support the electronic device.

One embodiment of a method for providing electrical power to an electronic device at a shelf of a gondola in a retail environment may include installing a power track including a structure member and at least two electrical conductors, where the structure member may be positioned along a bottom surface of the shelf of the gondola. A positionable shuttle may be coupled to the power track. The shuttle may be configured to conduct electricity from the at least two electrical conductors to the electronic device. An electronic device may be connected directly or indirectly to the shuttle. The shuttle may be positioned to cause the electronic device to be positioned relative to the shelf of the gondola.

One embodiment of a method for positioning an electronic device at a shelf-edge of a gondola in a retail environment may include moving a first, positionable member relative to a second member, both located at a shelf of the gondola, to reposition an electronic display relative to a shelf-edge. A lock may be engaged to prevent the electronic display from being moved or removed from the shelf. The lock in combination with other hardware thereby provides for parkability, which prevents movement and removability of the electronic display.

### BRIEF DESCRIPTION

A more complete understanding of the method and apparatus of the present invention may be obtained by reference to the following Detailed Description when taken in conjunction with the accompanying Drawings wherein:

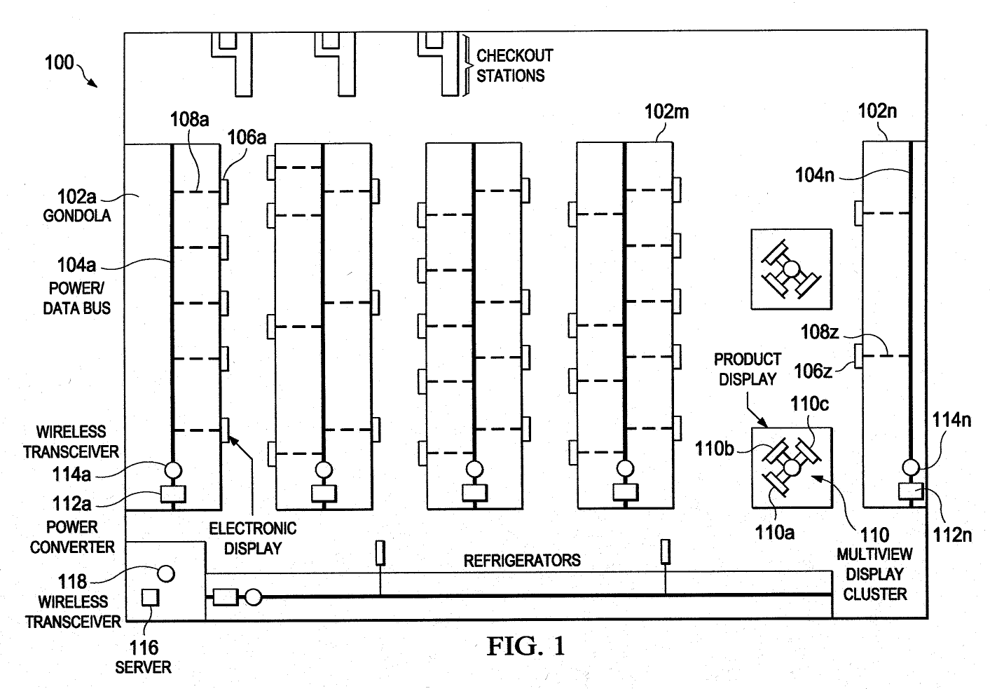

FIG. 1 is an illustration of an illustrative overview of a retail store including electronic displays positioned at shelf-edges supported by a power track and shuttle in accordance with the principles of the present invention;

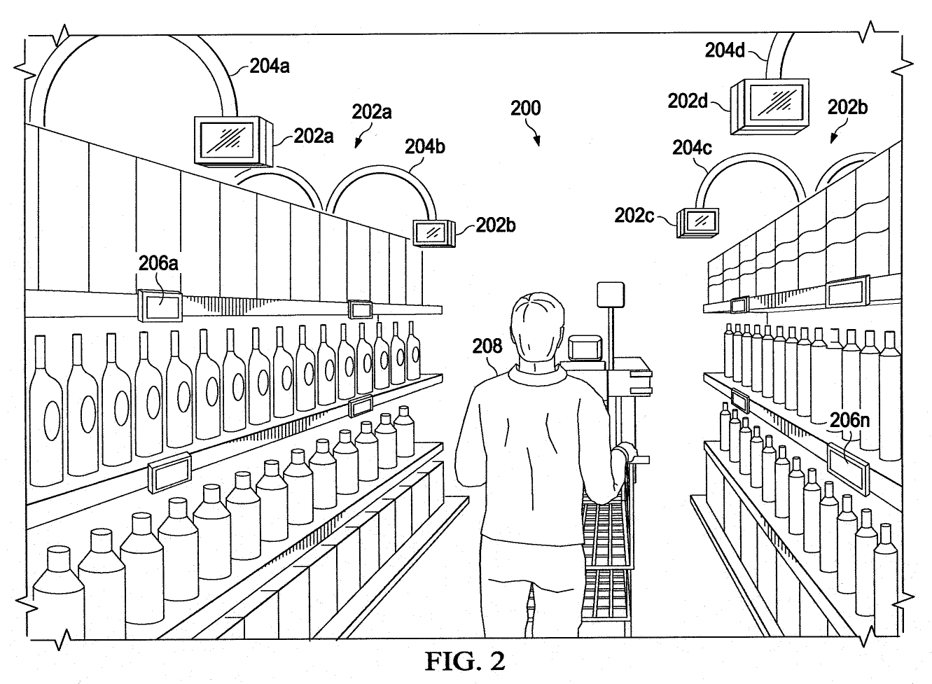

FIG. 2 is an illustration of an illustrative retail store aisle showing both line-of-sight (i.e., over the aisle) electronic displays and shelf-edge electronic displays, both of which are supported and powered by a power bus in accordance with the principles of the present invention;

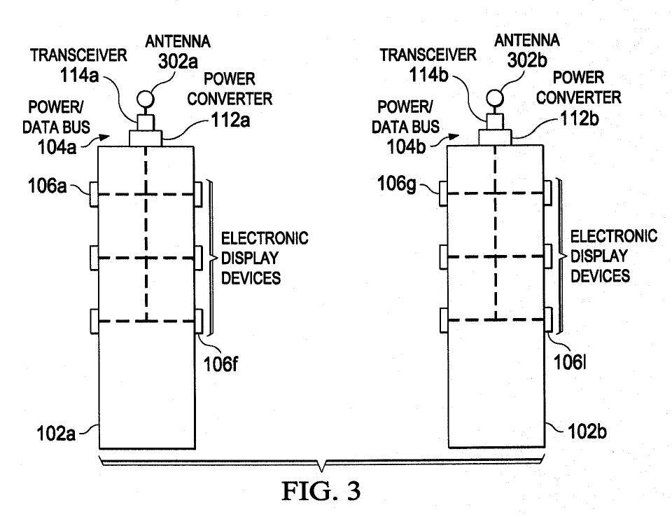

FIG. 3 is an illustration of a side view of illustrative gondolas showing power buses configured to supply power to electronic displays at the gondolas;

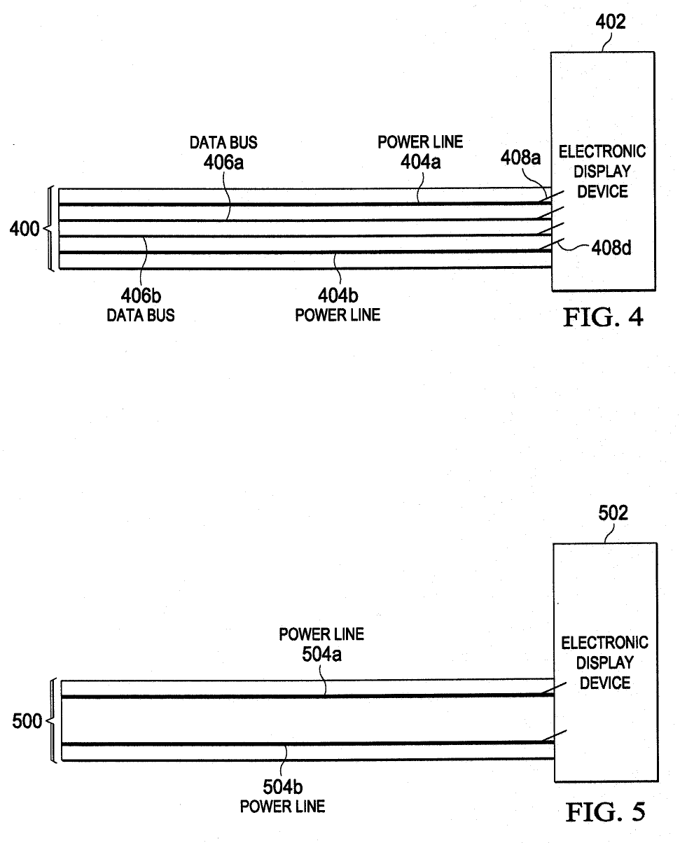

FIG. 4 is an illustration of an illustrative power bus with separate power lines and data lines;

FIG. 5 is an illustration of an illustrative power bus with power lines that are used to carry both power and data;

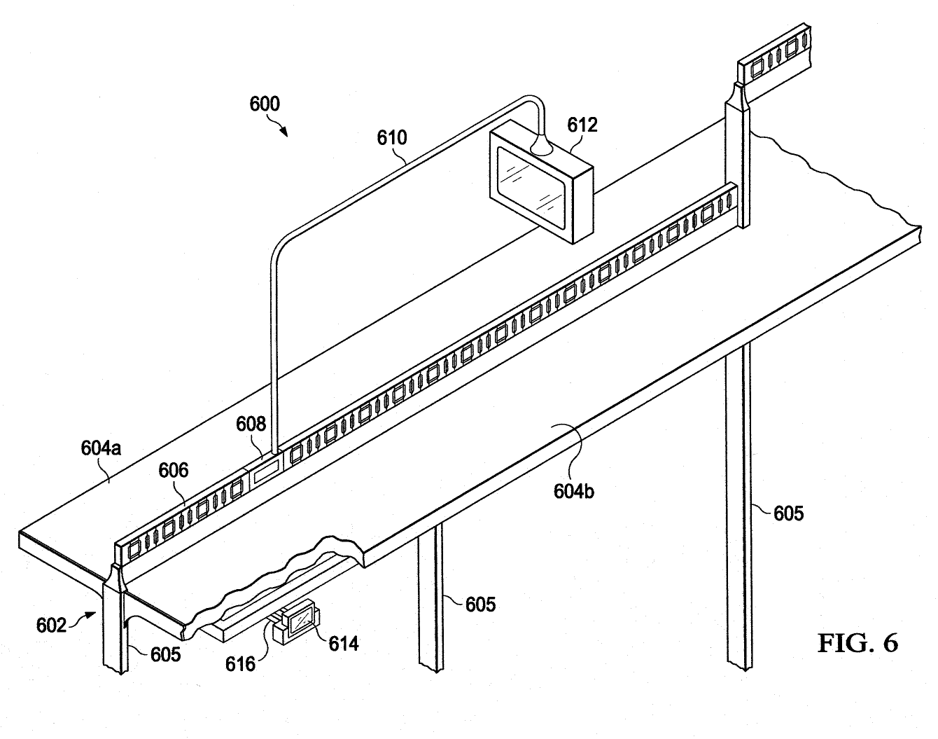

FIG. 6 is an illustration of an illustrative power bus configured onto a gondola to physically support and deliver power to electronic displays, including a shelf-edge electronic display mounted to a shuttle to provide for positioning adjustment; and

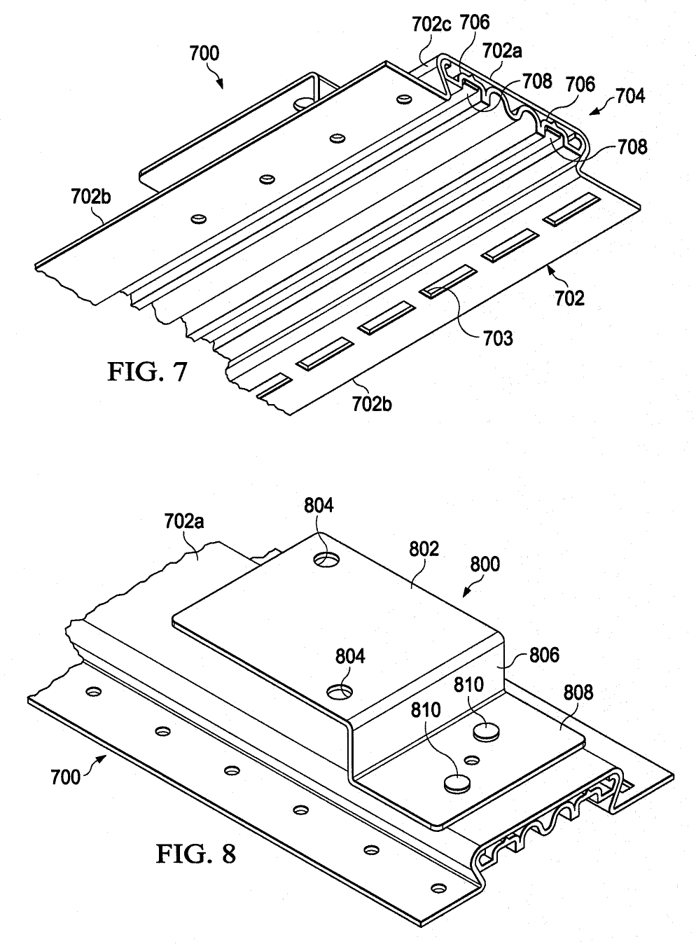

FIG. 7 is an illustration of an illustrative power track that is configured to be mounted below a shelf, enable a shuttle to be mounted thereto, and deliver power to an electronic display at a shelf-edge of a shelf;

FIG. 8 is another illustration of the power track of FIG. 7 showing a mounting bracket used to secure the power track to the underneath of a shelf, for example;

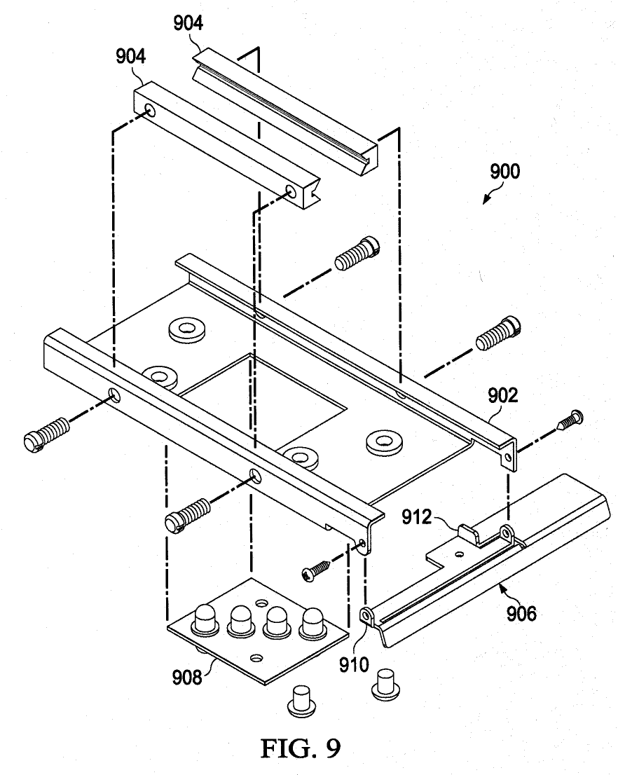

FIG. 9 is an illustration of an illustrative shuttle configured to mount to the power track, support an electronic display, and transfer power between the power track and the electronic display;

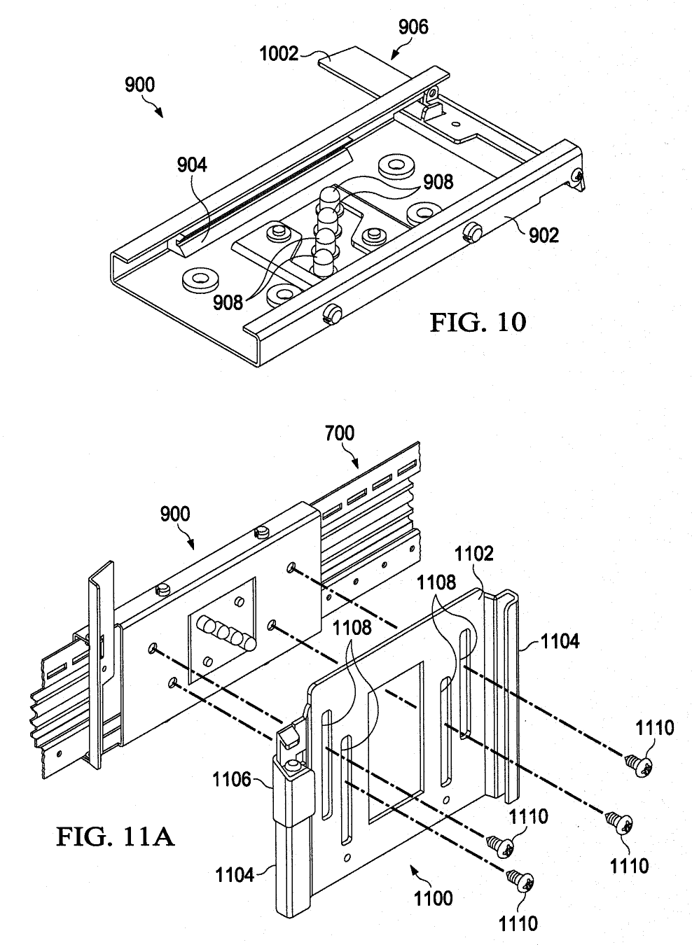

FIG. 10 is another illustration of the shuttle of FIG. 9 showing mounting components and electrical coupling components;

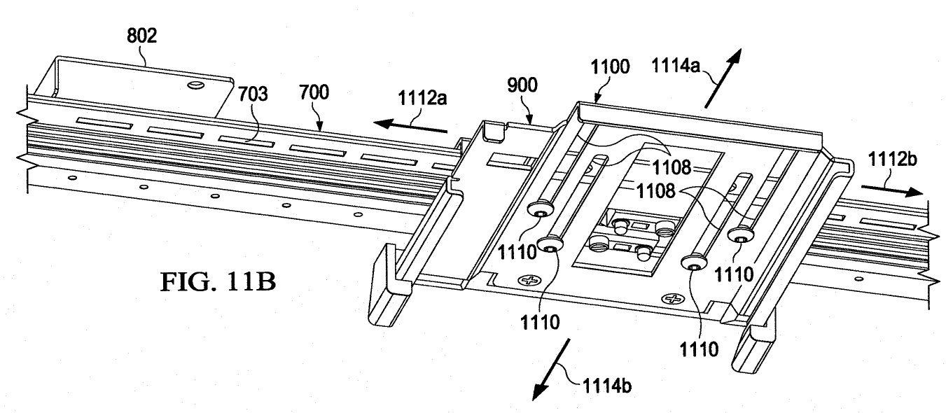

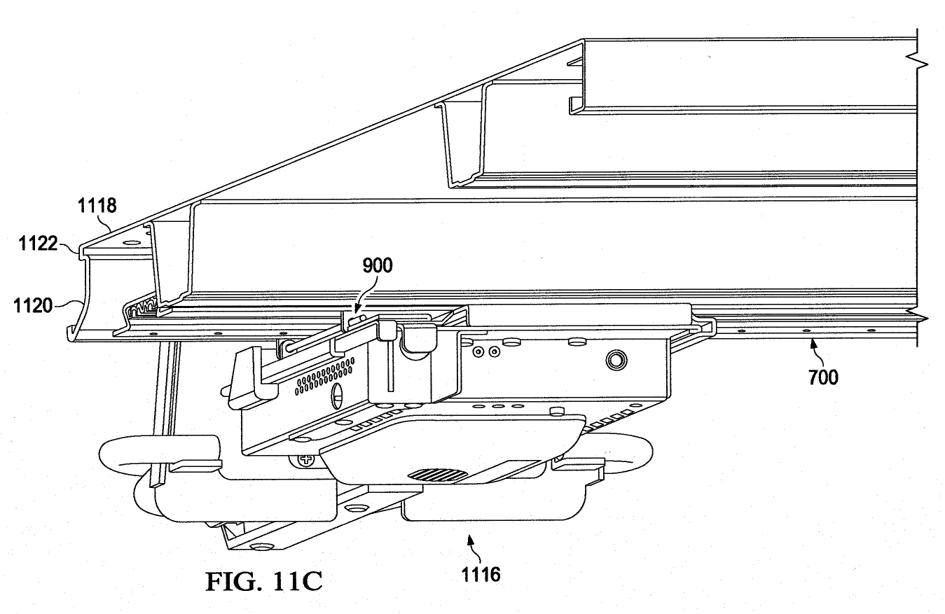

FIG. 11A is an illustration of the power bus of FIGS. 7 and 8 and shuttle of FIGS. 9 and 10 being coupled to one another, and a box holder that couples to the shuttle and provides physical support to an electronic display device;

FIG. 11B is an illustration of an illustrative assembly of the power track of FIG. 7, shuttle of FIG. 9, and box holder of FIG. 11A is shown;

FIG. 11C is an illustration of the assembly of FIG. 11B with an electronic display assembly mounted thereto as mounted to a shelf of a gondola;

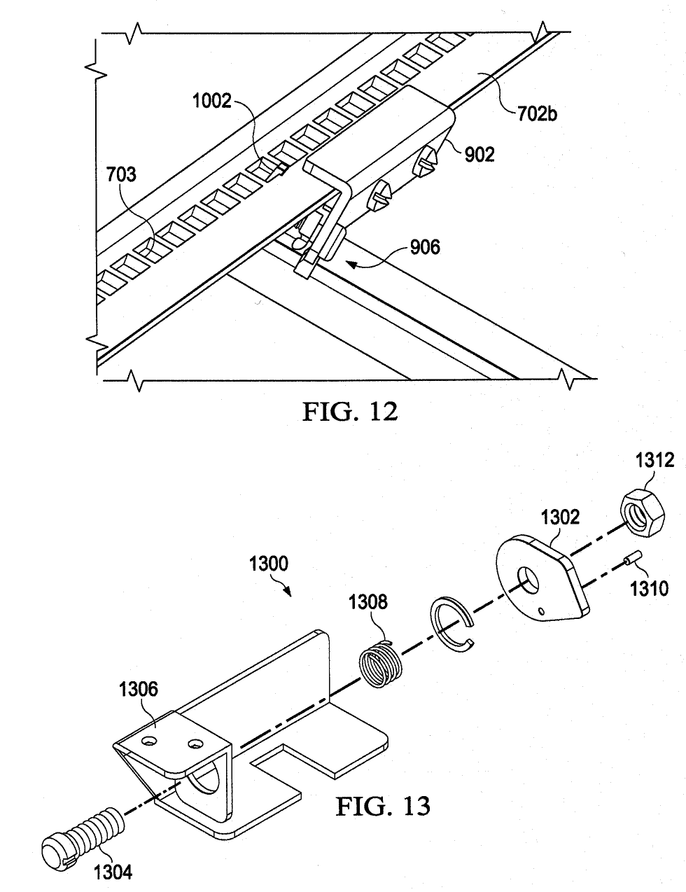

FIG. 12 is an illustration of the power track showing a brake of the shuttle used to lock the shuttle in place along the power track;

FIG. 13 is an illustration of an expanded view of a lock mechanism used to lock an electronic display device and box holder of FIG. 11 into the shuttle;

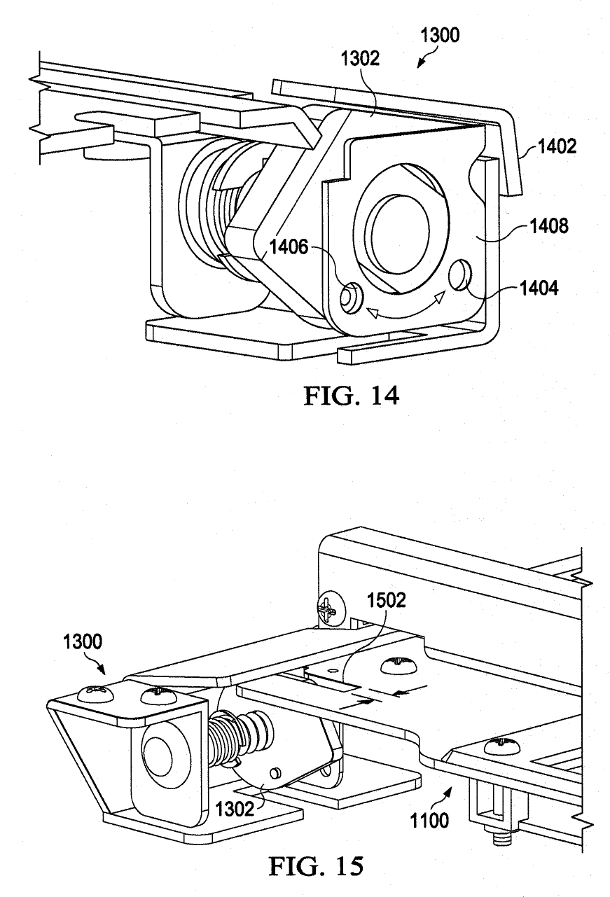

FIG. 14 is an illustration of the lock mechanism of FIG. 13 as assembled;

FIG. 15 is an illustration of the lock mechanism integrated into the box holder of FIG. 11;

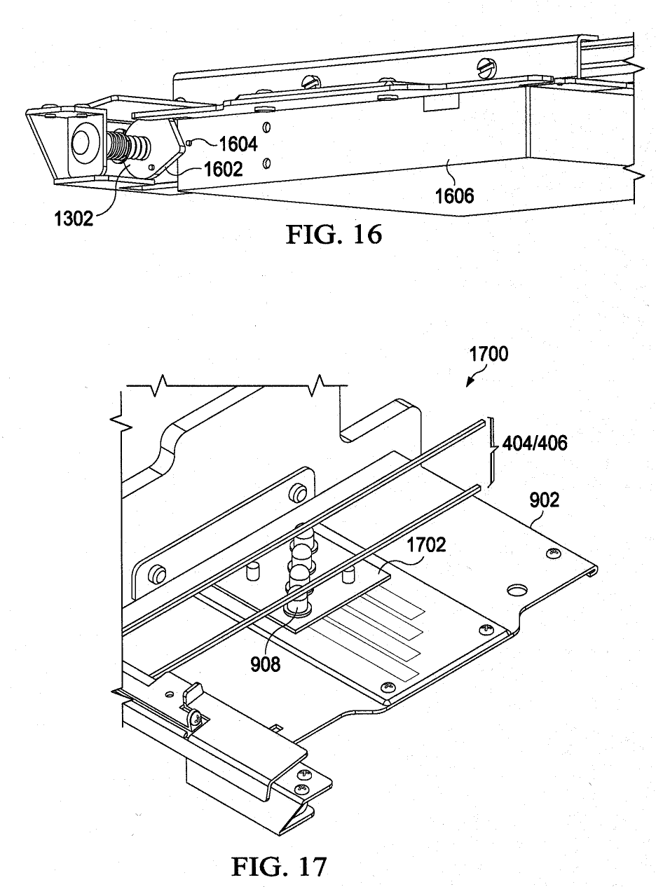

FIG. 16 is an illustration of the lock mechanism in an actuated position within the box holder;

FIG. 17 is an illustration of the box holder being aligned with the power track so that electrical contacts provided by the box holder can transfer power from the power bus to an electronic display device being supported by the box holder;

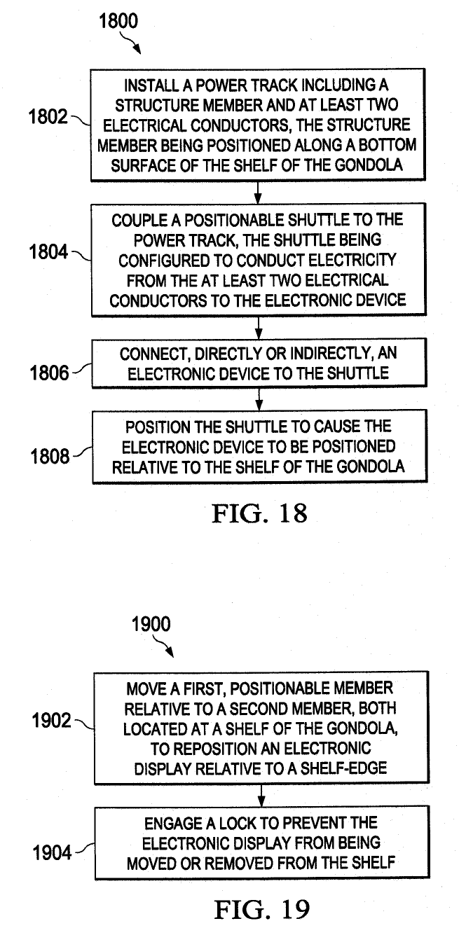

FIG. 18 is a flow diagram of an illustrative process for installing a power track on a shelf of a gondola to provide power to an electronic display device; and

FIG. 19 is a flow diagram of an illustrative process for positioning an electronic display device at a shelf-edge of a shelf on a gondola.

### DETAILED DESCRIPTION

With regard to FIG. 1, an illustrative retail establishment 100 is shown to include gondolas 102a-102n (collectively 102) that are used to display products in the retail establishment 100. Power/data buses 104a-104n (collectively 104; hereinafter “power buses”) may be attached to the gondolas 102 and used to deliver power on electronic displays 106a-106z that may be located at shelf edges of the gondolas 102. Power/data bus extension lines 108a-108z (collectively 108; hereinafter “power extension lines”) may connect power and/or data lines to each of the electronic displays 106 from the power/data buses 104 that extend along the gondolas 102. As further described herein, the power lines of the power buses 104 and power extension lines 108 may include high and low power lines, and the data lines of the power buses 104 and power extension lines 108 may include separate conductors or share the power lines. If the power lines are shared, then power line communications (PLC) may be utilized, as understood in the art. In addition to the electronic displays 106 being located at the gondolas 102, the principles of the present invention provide for non-gondola electronic display configurations, such as a multi-view display cluster 110 that includes multiple electronic display devices 110a-110c, ceiling mounted electronic display devices (not shown), wall mounted electronic display devices (not shown), floor mounted electronic display devices (not shown), and so forth. In any of these alternative electronic display device configurations, a power/data bus may be connected to a structure other than the gondola 102.

Each of the power buses 104 may have power converters 112a-112n (collectively 112) electrically attached and/or physically supported thereby. The power converters 112 may be configured to convert high voltage power level, such as 120V AC, accessible at the retail establishment into low voltage power level DC or AC power, such as 12V DC or AC power. The power converters 112 may include a transformer and/or rectifier circuitry, as understood in the art, for use in the conversion of the power. As understood in the art, data signals that are communicated over power lines have difficulty in crossing through transformers and other power conversion circuitry. As such, the principles of the present invention connect wireless transceivers 114a-114n to the power/data buses 104 on the side of the power converters 112 with the down-converted power.

The retail establishment 100 may include a server 116 that receives data signals from a remote location (e.g., central content distribution system) via a communications network, such as the Internet or satellite network, and communicates the data via a wireless network access point 118 to communicate the content within the retail establishment 100. The wireless network access point 118 may be configured to communicate using a WiFi® or 802.11 wireless communications protocol, as understood in the art. Alternative wireless communications protocols may be utilized in accordance with the principles of the present invention. In one embodiment, the wireless network access point 118 is capable of communicating wireless signals throughout the entire establishment so that a single wireless network access point may be utilized in the retail establishment. Alternatively, multiple network access points 118 may be utilized in larger retail establishments. However, even having a wireless network access point(s) 118 having a signal strength high enough to communicate throughout the entire establishment, it should be understood that because of metal shelving and other materials of products in the retail establishment, that electronic display devices 106 that are positioned on lower shelves and are not within a line of sight of the wireless network access point(s) 118 may have difficulty in receiving the communications signals. Therefore, by including wireless transceivers 114 on the gondolas 102 and communicating the data signals along the power bus to the electronic display devices 106, each of the electronic display devices 106 may receive the communications signals with reduced risk of failure due to the metal shelving and products in the retail establishment.

With regard to FIG. 2, an illustration of a store aisle 200 in a retail environment is shown to include electronic display network equipment that includes electronic display devices 202a-202d (collectively 202) that are supported by extension arms 204a-204d (collectively 204) that are connected to and supported by a power bus (not shown) that may include power for delivering power to the electronic display devices 202, as described with regard to FIG. 1. Shelf-edge electronic display devices 206a-206n (collectively 206) may be powered by the power extension lines that extend from the power buses. In one embodiment, the power extension lines may be passed through an under-shelf track that mounts to the bottom of a shelf. Alternatively, the power extension lines may be power configured as cables that connects to power dropdown cables that extend down a vertical wall of the gondola behind the shelves. A shopper 208 traversing down the aisle 200 may view the electronic display devices 202 and 206. In the case of using an under-shelf power track and shuttle assembly to which the shelf-edge electronic display devices 206 are mounted, the shelf-edge electronic display devices 206 are secured such that a customer cannot remove the electronic display devices and the ability for the electronic display devices 206 to be stolen is minimized, as further described herein.

With regard to FIG. 3, two illustrative gondolas 102a and 102b are shown to include a power buses 104a and 104b, respectively, for delivering power and/or data to and from electronic display devices 106a-106f and 106g-106l, respectively. Attached to each of the power buses 104a and 104b are power converters 112a and 112b, respectively. As previously described, the power converters 112a and 112b convert electrical power signals provided by the retail establishment into power signals that may be used to power the electronic display devices 106 in either AC or DC format. Transceivers 114a and 114b may be connected to respective power buses 104a and 104b to receive and to distribute data signals to the electronic display devices 106 on the respective gondolas 102a and 102b. Antennas 302a and 302b may also be utilized to transmit and receive data communications signals with a wireless network access point in the retail establishment, where the wireless network access point may connect to a local or wide area network.

With regard to FIG. 4, an illustration of an illustrative power bus 400 in communication with an electronic display device 402 is shown. In one embodiment, the power bus 400 includes two power lines 404a and 404b that are used to communicate power signals to power the electronic display device 402. In addition, two data bus lines 406a and 406b are used to communicate data signals to the electronic display device 402. Conductors 408a-408d may connect the electronic display device 402 to the power bus 400.

With regard to FIG. 5, an illustration of an alternative illustrative power bus 500 is connected to an electronic display device 502. In this embodiment, the power bus 500 includes two conductor lines 504a and 504b that may be used to communicate both power and data signals to the electronic display device 502. In this embodiment, the power line communication protocol may be utilized. As understood in the art, the power line communication protocol uses AC power signals so that data signals may be communicated over the power lines. In such an embodiment, the electronic display device 502 may include a rectifier or other power conversion circuitry for powering electronics within the electronic display device 502. Alternatively, direct wireless communications, such as WiFi, may be used to communicate with the electronic display device 502 or any other electronic device.

With regard to FIG. 6, an illustrative power bus 600 that is capable of delivering power to a retail store gondola 602 in an economical manner is shown. The gondola 602 includes shelves 604a and 604b that are supported by vertical support members 605. A horizontal support structure or power tube 606 extends horizontally across the gondola 602. The power tube 606 is supported by the vertical support members 605. In one embodiment, extension members (not shown) are configured to attached to the power tube 606 and extend downward through openings (not shown) at the top of the vertical members 605, as understood in the art. The extension members may be configured to be universal in that one configuration of an extension member may adapt to extend through different brands and configurations of vertical support members.

The power tube 606 is configured to both support electronic display devices and provide electricity by housing electrical conductors, such as either of those shown in FIGS. 4 and 5, thereby allowing for tapping of the electrical conductors along the power tube 606. In one embodiment, the power tube 606 may be substantially rectangular (e.g., with rounded edges) that have a longer height than width, thereby providing for torque resistance. Alternative torque resistant configurations may alternatively be utilized. As shown a coupler member 608 may be coupled to the power tube 606 to physically support an extension tube 610 that physically supports an electronic display device 612. The coupler member 608, in one embodiment, may include rollers (not shown) that enable the coupler member 608 to be rolled down the power tube 606. Alternatively, the coupler member 608 may use connector hardware (e.g., screws) that fixedly secure the coupler member 608 to the power tube 606 without having the ability to be moved or repositioned along the power tube 606 without being removed while being repositioned.

As shown, the power tube 606 has openings along the sides of the power tube 606, thereby enabling an electrical connector (not shown) to extend into the power tube 606 to make electrical contact with power rails that extend through the power tube 606 in the same or similar configuration as shown in FIG. 7 with regard to the power track. In an alternative configuration, rather than having opening through which an electrical connector extends to contact power rails, connectors (not shown) that are electrically connected to the power rails or alternative electrical conductors may be positioned in openings on the side of the power bus to which a connector (not shown) on a cable connected to an electronic device or electrical conductor may be connected. For example, the connector on the power tube 606 may be a female connector to which a male connector connects. The connectors may be standard or proprietary and may provide for power or power and data conductors.

The power tube 606 may be a lightweight, extremely strong tube, which may be metallic or other similarly strong material, that runs along the top center of gondolas, freezer/cooler tops, and the top of wall mounted shelves and walls. If the gondola includes a stanchion extension, the power tube 606 may be configured to accommodate for a “break” and reroute along the top of the gondola by using rise and end brackets along with a short power tube, as shown.

In one embodiment, the power tube 606 may be configured to house power rails over which power may be conducted. The power tube 606 may be configured to receive power from power poles coming down from a suspended ceiling, fan braces/power boxes in the suspended ceiling, power outlets along walls and on top of coolers, refrigerated cases and freezers, and various other locations throughout the retail environment. Rather than using 120V AC power, for safety purposes, a power converter (not shown) may be configured to transform the power to a lower power, either AC or DC, as understood in the art. In one embodiment, 12V DC power may be delivered along the power rails of the power tube 606 for supplying power to the electronic display devices. Alternatively, if power line communications are utilized, a low voltage AC power may be utilized, as understood in the art and further described herein.

Continuing with FIG. 6, a shelf-edge electronic display device 614 is shown to be supported by a power track (see FIG. 7) and shuttle 616 (see FIGS. 9-11). As understood in the art, different support structures may be used for different configurations of shelves on gondolas (i.e., support bars have different positions on different makes and models of gondolas). The combination of the power track and shuttle 616 provides for variability in positioning, such that different configurations of gondolas and associated shelving can be accommodated through positioning adjustment of the shuttle 616 along the power track.

With regard to FIG. 7, a power track 700 is shown to include a structure member 702 and power rail member 704. The structure member 702 includes a base portion 702a and wing portions 702b, which extend from both sides of the base portion 702a. The structure member 702 may be formed of a metallic material, such as rolled steel, or other stiff material. A bend portion 702c connect the base portion 702a and wing portions 702b. The wing portions 702b may include rectangular cutouts 703 that provide for securing a shuttle in place, as further described herein. As a whole, the structure member 702 forms a trapezoidal shape that allows for the power rail member 704 to be engaged and supported by the structure member 702, and also allows for the power rail member 704 to be exposed along the length of the power track 700. The power rail member 704 includes an insulator 706, which may be extruded, and bus bars 708. The bus bars 708 extend along the insulator 706 and are capable of conducting electricity up to a power level utilized by the electronic devices drawing power from the power track 700. The power track 700 may be utilized to distribute power along the complete length of the front edge of a shelf. As a result, the front edge of the shelf has a constant, consistent source of power, either DC or AC, and a robust movable/parkable attachment point from which an electronic device may be positioned.

The power track 700 may be mounted under the shelf in a fashion that is hidden behind the front edge of the shelf. As understood in the art, the front edge of the shelf often has a “lip” or “ticket track,” where a retailer typically provides pricing and other information. To accommodate the shelf and ticket track, the power track 700 may be mounted under the shelf. The configuration of the ticket track is designed to have minimal or no interference with the top and front edge of the shelf. A further constraint for mounting and configuring the power track 700 is that the different gondola manufacturers all design and manufacture their shelves in different ways (even in the same manufacturer, the shelf designs may vary).

The task of bringing low voltage power and data communications, parkability, and movability to the edge of the shelf may be solved using the following components to complete a power track system: a power track, an insulated accessible power conductor, a shuttle or slider capable of locking in position, a power and data pick-up connector, and a mechanical receiver or box holder capable of supporting and connecting an electronic device (e.g., electronic display device).

With regard to FIG. 8, the power track 700 of FIG. 7 may be configured with a mounting bracket 800 is shown. The mounting bracket 800 may be a piece of metal or other material that has a shelf connection portion 802 that is adapted to be connected to the underside of a shelf. In one embodiment, the shelf connection portion 802 may include openings 804 that allow for connection members, such as nuts and bolts, to be inserted therethrough. A standoff portion 806 may provide some amount of separation, such as one-half inch, from the bottom of the shelf to clear the ticket track (see FIG. 11B). A power track 700 connection portion 808 may provide for connection to the base portion 702a of the power track 700. Openings 810 may allow for connection members to fasten the mounting bracket 800 to the base portion 702a. Alternatively, rather than using a mounting bracket 800, direct attachment members (e.g., nuts and bolts) may connect the power track 700 to the shelf underside or shelf supports. It should be understood that alternative configurations may be utilized. The shape of the track is made to support the devices that are directly or indirectly mounted to and powered by the power track. It should be understood that alternative shapes may be utilized for the power track that provide the same or equivalent functionality.

With regard to FIG. 9, an illustration of an illustrative exploded view of a shuttle 900 is shown. The shuttle 900 may include many elements, including track guide 902, guide block 904, brake assembly 906, unit security lock (FIGS. 13-16), and a contact block 908, which provides for power and data pickup and transfer. The track guide 902 may be slid onto the wing portion 702b (FIG. 7) of the power track 700. The guide block 904 provides for the shuttle 900 to be easily slid along the power track 700. The guide block 904 may have a material, such as plastic, that reduces friction and is smooth. The brake assembly 906 may include a brake hinge 910 that allows locking teeth 912 to rotate into and out of the rectangular cutouts 703 of the wing portion 702b of the power track 700. In one embodiment, the contact block may include two or more double-ended, spring loaded contacts that operate as electrical conductors to transfer electricity from the bus bars or power rails 708 and/or data lines of the power track 700 to bus bars (not shown) of the shuttle 900, other conductive structure, or directly to an electronic device being physically supported by the shuttle 900. The double-ended, spring loaded contacts (i) accommodate for variability of height of the power rails, thereby (a) maintaining physical and electrical contact while moving the shuttle 900 relative to the power track 700, (b) maintaining physical and electrical contact while moving the box holder 1100 relative to the shuttle 900 (see FIGS. 11A-11C), and (ii) eliminate having to perform traditional wiring connections.

With regard to FIG. 10, the shuttle 900 is shown in an assembled configuration. As shown, the track guide 902 operates as an open box within which the guide block 904 resides. The guide block 904 may include a bushing that provides tolerance absorption, controls friction, and mitigates wear between the sliding surfaces. The brake assembly 906 is positioned on one side, but alternative configurations may be utilized. A brake member 1002 of the brake assembly 906 may be rotated to be inserted into an opening, such as a rectangular cutout 703, of the power track 700 (see FIG. 12). In an alternative configuration, the brake member 1002 may be configured as a rotatable cam that allows for the brake member 1002 to slide into and out of an opening by a half-turn, for example, of the brake member 1002.

With regard to FIGS. 11A-11C, an exploded view of the power track 700 and shuttle 900 is provided. A box holder 1100, which is to be connected to the shuttle 900, is also shown. The box holder 1100 provides the ability to physically support an electronic display device (see FIG. 6) or other electronic device. The box holder 1100 may include a base portion 1102 and rail guides 1104 that extend from the base portion 1102 to allow for a box of the electronic device to be guided and connected to the box holder 1100. The box holder 1100 may also include a security lock 1106 that allows for the box holder 1100 to be fixedly attached to the shuttle 900. Slots 1108 in the base portion 1102 provides for adjustment of the position of the box holder 1102 with respect to the shuttle 900, thereby accommodating for the box holder 1100 and electronic device to be slid in and out to avoid products and shelving structure. Fastener members 1110, such as screws, that pass through the slots 1108 allow for the box holder 1100 to be moved relative to the shuttle 900 without being separated, thereby providing for adjustment of an electronic display relative to a shelf-edge.

An electronic device, such as an electronic display device, that is positioned along the shelf edge may be inserted and removed, at will, in a quick fashion by an operator. However, the electronic device should not be moved or removed by anyone else (e.g., shopper or child of a shopper). The security lock 1006 may be used to prevent movement and, consequently, movement and removal of an electronic device connected to the box holder 1100. It should be understood that the combination of the shuttle, box holder, and security lock 1006 ultimately provides for parkability since hardware used to secure the device both in movement along the power track and removal from the power track cannot be accessed without the security lock 1006 being in an unlocked position (i.e., screws and other fastening hardware are not accessible due to being covered by the box holder 1100 or other members without being physically removed from the power track). The security lock 1106 may be simple to operate and provide positive latching. The security lock 1106 may be operated by inserting a tool into a hole in the front of the box holder 1100 and engaging an internal mating surface having a specific shape. The security lock 1106 may then be actuated by pushing in against a spring loaded shaft and turning 90 degrees clockwise. This action may turn a cam shaped plate that performs one or more functions, as further described below.

First Cam Function. With regard to FIGS. 13 and 14, an exploded view of an illustrative security lock 1300 is shown. A cam 1302 is shown to have a radius increase with radial angle, as understood in the art. The increase in radius of the cam 1302 is along an edge of a brake actuator 1402 follows. The cam 1302 is aligned with the brake assembly 906 (FIG. 9) so that when the security lock 1300 is engaged, the increase in radius causes the brake member 1002 (FIG. 10) to be inserted into the locked position. Once the brake member 1002 is in the locked position, the electronic device is prevented from being moved laterally along the edge of the shelf and/or being removed from the shelf (i.e., parkability). The security lock 1300 may further include a lock screw 1304, lock bracket 1306, spring 1308, pin 1310, and nut 1312. These components may provide for a secure locking mechanism, as described herein.

Second Cam Function. With regard to FIG. 15, the increased radius of the cam 1302 falls into a slot 1502 that is cut in the box holder 1100. The engagement of the cam 1302 in the slot 1502 prevents a box or housing of an electronic device from being pulled out of the box holder 1100, thereby providing detachment security.

Third CAM Function. With regard to FIG. 16, the cam 1302 may include a flat side 1602 that, when the cam 1302 is rotated, presses onto a switch (not shown) that is mounted inside of a housing 1606 of the electronic device. The switch may include an actuation finger 1606 or other actuation member that sticks out of a hole of the housing 1606. The switch may be in a direct electrical path of electricity being applied from the power track 700 to the electronic device. As understood in the art, the closing of the switch enables power to be delivered to the appliance.

Fourth Cam Function. With further regard to FIG. 14, two detent holes, an unlocked detent hole 1404 and a locked detent hole 1406, in a box holder lock guide plate 1408. The cam 1302 has a hemispherically rounded pin mounted thereto at a side location. When the user pushes in and rotates the handle of a locking tool (not shown), the cam 1302 rotates from its detented open position, which causes a hemispherical rounded pin to slide along a surface of the box hold plate 1408 between the two holes 1404 and 1406 to eventually fall into the locked detent hold 1406. These detented positions provide feedback to the user that the lock has found its proper closed (or open) position. The detent holes 1404 and 1406 also keep the cam 1302 from freely turning due to shock or vibration, thereby making it difficult to release the unit or move the unit without purpose. It should be understood that alternative locking configurations may be utilized in accordance with the principles of the present invention. For an example, rather than the security lock 1106 being integrated into box holder 1100, a security lock may be integrated into a housing of the electronic device.

With regard to FIG. 17, a power pickup and transfer system 1700 is shown. As previously described, the power track 700 (FIG. 7) has the inverted trapezoidal shape that is open along the length of the shorter of the two wide sides of the trapezoid. The open side has exposed the face surface of the custom extruded insulator 706 (FIG. 7). That open face has power and data conductors or bus bars 404/406 (FIG. 4) mounted thereto. By having the faces of the conductors exposed along the whole length of the track, continuous access to power while moving a device along the track is provided. In an alternate design, the copper may be sheathed and the contacts may penetrate the covering material in order to pick up power and data communications. In yet another embodiment, an inductive, non-contact power interface, such as those used for electronic toothbrushes, may be utilized. In order to pick up continuous power and data communications, double-ended spring loaded contacts 908 may be employed, as previously described. The spring loaded contacts 908 may be mounted in an electrically insulated plate 1702. The plate 1702 may be positioned in the track guide 902.

When the track guide 902 moves, the contacts 908 also moves and maintains contact with the conductors 404/406 through the length of the track. By virtue of the double-ended nature of the contacts 908, the power can now be passed to an electronic device that is inserted into the box holder 1100. The electronic device, too, may include a track type of contact area that may be disposed on a printed circuit board. This system of electrical pick-up and pass-through by use of double ended spring loaded contacts is very efficient from a manufacturing standpoint because it contains no wires, cables, or soldering. The manufacturing assembly is simplified compared to other solutions and the act of mating electrically is performed in a passive manner during mechanical insertion of the appliance in the box holder. It should be understood that alternative configurations that provide the same or similar functionality may be utilized in accordance with the principles of the present invention. As an example, rather than the security lock 1106 being integrated into box holder 1100, a security lock may be integrated into a housing of the electronic device, as shown in FIG. 11C.

The collection of the above subassemblies creates a robust form of accessible power, data communications, and mechanical mounting along the edge of the retail shelf wherever the power track is placed. As a result, delivering power and data communications to retail shelves to power electronic devices is provided in a cost effective manner as the power track 700 and power tube 606 can be adapted to existing shelving with minimal or no interference with product displays.

With regard to FIG. 11B, an illustration of an illustrative assembly of the power track 700 of FIG. 7, shuttle 900 of FIG. 9, and box holder 1100 of FIG. 11A is shown. As previously described, the shuttle 900 is movable relative to the power track 700, which is fixedly attached to a shelf (or other member) of the gondola. If the power track 700 is mounted parallel to a shelf-edge, the shuttle 900, and consequently electronic display, is capable of being moved horizontally (i.e., along the X-axis) along the shelf, as indicated by arrows 1112a and 1112b. The box holder 1100, having slots 1108 and fasteners 1110 that provide for movement of the box holder 1110 relative to the shuttle 900, enables an electronic display to be moved vertically (i.e., along the Y-axis, in this case perpendicularly outward from the shelf to a walkway) along the shelf, as indicated by arrows 1114a and 1114b. By providing for vertical movement, the electronic device may be adjusted in position to be farther or closer to the shelf-edge of the shelf.

With regard to FIG. 11C, an illustration of an isometric rear view of the assembly of FIG. 11B with an electronic display assembly 1116, which includes an electronic display (see FIG. 6) mounted thereto as mounted to a shelf 1118 of a gondola. As shown, the shelf 1118 includes a ticket channel 1120 at a front edge 1122 of the shelf 1118. The assembly of the power track 700, shuttle 900, and box holder 1100 provides flexibility for installation and movement of the electronic display assembly 1116 with respect to the shelf-edge 1122 of the shelf 1118.

With regard to FIG. 18, a flow diagram of an illustrative process 1800 for installing a power track on a shelf of a gondola to provide power to an electronic display device is shown. The process 1800 starts at step 1802, where a power track including a structure member and at least two electrical conductors may be installed. The structure member may be positioned along a bottom surface of the shelf of the gondola. In one embodiment, the structure member may be connected to the bottom of the shelf. Alternative connection points may be made to position the structure member beneath the shelf. At step 1804, a positionable shuttle may be coupled to the power track. In coupling the shuttle, a track guide may used in connecting the shuttle to the power track, thereby providing reduced friction to allow the shuttle to slide along the power track. In one embodiment, the shuttle may be configured to conduct electricity from the electrical conductors to the electronic device. An electronic device may be connected directly or indirectly to the shuttle. In one embodiment, a box holder may be utilized to indirectly connect the electronic device to the shuttle. Alternatively, the electronic device may include a housing that accommodates for direct connection to the shuttle. The shuttle may be positioned to cause the electronic device to be positioned relative to the shelf of the gondola (e.g., moved to be positioned in front of different items on a shelf).

With regard to FIG. 19, an illustrative process 1900 for positioning an electronic display device at a shelf-edge of a shelf on a gondola is shown. The process 1900 may include moving a first, positionable member relative to a second member, both located at a shelf of the gondola, to reposition an electronic display relative to a shelf-edge. A lock may be engaged to prevent the electronic display from being moved or removed from the shelf. In one embodiment, the lock may prevent the second member from being moved relative to the shelf.

It should be understood that the system and methodology described herein may be utilized for electrical and non-electrical devices and/or displays in a retail environment. It should further be understood that alternative configurations may be utilized in accordance with the principles of the present invention.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A power bus system for providing electrical power to an electronic device at a shelf of a gondola in a retail environment, said power bus system comprising:
a power track including a structure member and at least two electrical conductors, the structure member being positioned along a bottom surface of the shelf of the gondola;
a shuttle coupled to said power track, and configured to be positionable along said power track and to conduct electricity from the at least two electrical conductors to the electronic device; and
a box holder connected to said shuttle, and configured to physically support the electronic device.

2. The power bus system according to claim 1, wherein said shuttle includes a guide block configured to slide along the structure member of said power track.

3. The power bus system according to claim 2, wherein the structure member includes wing portions on which the guide block slides.

4. The power bus system according to claim 1, wherein said shuttle includes a contact block configured to conduct electricity from the at least two electrical conductors to the electronic device.

5. The power bus system according to claim 4, wherein the contact block includes double-ended spring loaded contacts to conduct power from the at least two electrical conductors to the electronic device.

6. The power bus system according to claim 1, wherein said shuttle includes a brake assembly configured to engage the structure member to prevent relative movement of said shuttle with respect to said power track.

7. The power bus system according to claim 6, wherein said brake assembly includes a rotatable member that causes a brake member to enter an opening along the structure member.

8. The power bus system according to claim 6, further comprising a security lock that, when in a locked position, causes the brake assembly to engage the structure member, and when in an unlocked position, causes the brake assembly to disengage from the structure member.

9. The power bus system according to claim 8, wherein said security lock is fixedly attached to said shuttle.

10. The power bus system according to claim 1, wherein the at least two electrical conductors include at least two conductor rails to conduct power and at least two conductor rails to conduct data signals.

11. A method for providing electrical power to an electronic device at a shelf of a gondola in a retail environment, said method comprising:
installing a power track including a structure member and at least two electrical conductors, the structure member being positioned along a bottom surface of the shelf of the gondola;
coupling a positionable shuttle to the power track, the shuttle being configured to conduct electricity from the at least two electrical conductors to the electronic device;
connecting, directly or indirectly, an electronic device to the shuttle; and
positioning the shuttle to cause the electronic device to be positioned relative to the shelf of the gondola.

12. The method according to claim 11, wherein sliding the shuttle along the power track.

13. The method according to claim 1, wherein conducting electricity at the shuttle from the at least two electrical conductors to the electronic device.

14. The method according to claim 13, wherein conducting electricity includes conducting electricity through double-ended spring loaded contacts to conduct power from the at least two electrical conductors to the electronic device.

15. The method according to claim 11, further comprising engaging a brake assembly of the shuttle the structure member to prevent relative movement of the shuttle with respect to the power track.

16. The method according to claim 15, engaging said brake assembly includes rotating a brake member to enter an opening along the structure member.

17. The method according to claim 15, further using a key to engage a security lock that, when transitioned to a locked position, causes the brake assembly to engage the structure member, and when transitioned to an unlocked position, causes the brake assembly to disengage from the structure member.

18. The method according to claim 17, further comprising fixedly attaching the security lock to the shuttle.

19. A method for positioning an electronic device at a shelf-edge of a gondola in a retail environment, said method comprising:
moving a first, positionable member relative to a second member, both located at a shelf of the gondola, to reposition an electronic display relative to a shelf-edge; and
engaging a lock to prevent the electronic display from being moved or removed from the shelf.

20. The method according to claim 19, further comprising moving the second member relative to a third, fixed member at the shelf to reposition the electronic display from a first position to a second position along the shelf-edge.

21. The method according to claim 19, wherein moving includes moving the first, positionable member perpendicular relative to the shelf-edge.
